(19) United States
(12) Patent Application Publication
(10) Pub. No.: US 2011/0296530 A1
(43) Pub. Date: Dec. 1, 2011

(54) ELECTRONIC READING APPARATUS AND THE DATA SECURITY METHOD THEREOF

(75) Inventors: YAO-CHOU TSAI, HSINCHU CITY (TW); SUNG-HUI HUANG, HSINCHU CITY (TW); CHIA-CHUN YEH, HSINCHU CITY (TW); TED-HONG SHINN, HSINCHU CITY (TW)

(73) Assignee: E INK HOLDINGS INC., HSINCHU CITY (TW)

(21) Appl. No.: 12/857,663

(22) Filed: Aug. 17, 2010

(30) Foreign Application Priority Data
May 26, 2010 (TW) 99116896

(51) Int. Cl. G06F 21/00; G06F 1/26

(52) U.S. Cl. 726/26; 713/320; 726/36

(57) ABSTRACT

Present invention relates to an electronic reading apparatus with data security and anti-theft functions. The electronic reader apparatus has a code input unit for receiving a security code, and a code determining unit for determining an authenticity of the security code. When no security code, no authentic security code or even no operational signal has been received during the predetermined periods of time, a central control unit may stop a power supply unit from outputting power in order to turn off the electronic reader apparatus and clear the image shown on a display unit. As such, a content of sensitive or confidential data stored in the electronic reading apparatus may not be intruded.

### BACKGROUND OF THE INVENTION

1. Field of the Invention

The present invention relates to an electronic apparatus; in particular, to an electronic reading apparatus with data security and anti-theft functions.

2. Description of Related Art

Due to the trend of portability and slim-sized design in various electronic apparatus currently available on the market and the prevalence of environment protection consciousness worldwide, the electronic paper display technology fulfills requirements on low power consumption, light and miniaturized profile, flexibility and reduction in amount of paper used as well as so forth is now comprehensively employed in different types of electronic products, such as electronic reading apparatus, cellular phone, Personal Digital Assistant (PDA), or potentially applied in the fields like notebook computer, vehicle displays etc. within foreseeable future.

The electronic paper display technology is a display technology having a bi-stable characteristic. Therefore, once an image has been refreshed, continuous power supplying may not be necessary for displaying the image until the image being refreshed again, thereby achieving an objective of power-saving.

Since the image could be displayed on the electronic paper without the continuous power supplying, the content of the image may be accessed without any authorization.

For achieving the objective of protecting the personal profile and confidential information stored in the electronic apparatus, the aforementioned situation could be remedied by periodical security codes input requests, and turning off the power supply of the electronic reading apparatus, or reducing the energy of the power supplying unit for stopping the operation of the electronic apparatus. However, the personal profile and confidential information stored in the electronic apparatus, with electronic paper technology, might still be intruded due to the continuous displaying image.

Meanwhile, most mobile devices, such as cellular phone, PDA etc., despite offering the functionality of restricting the information to limited audience, they generally could not enable/disable that particular functionality in a real-time manner.

### SUMMARY OF THE INVENTION

According to an objective of the present invention, an electronic reading apparatus with data security and anti-theft functions is provided. The electronic reading apparatus employs a code unit and a corresponding code input unit for receiving a security code. Then, the code determining unit compares the received security code with a pre-recorded one before to determine whether to turn off or to normally operate, so that clear the image on the display unit.

According to another objective of the present invention, an electronic reading apparatus might turn off or suspend the operation thereof when no operation signal has been received or no authentic security code has been received for a predetermined period of time.

The aforementioned summary and following detailed descriptions as well as appended drawings are exemplary for further explaining the approaches, means and effects taken by the present invention in order to effectively achieve the predetermined objectives. Other goals and advantages in relation with the present invention will be also illustrated in the subsequent descriptions and appended drawings.

### BRIEF DESCRIPTION OF THE DRAWINGS

FIG. 1 shows an electronic apparatus with data security and anti-theft functions according to an embodiment of the present invention;

FIG. 2 shows a flowchart for the method of data security in an electronic apparatus according to an embodiment of the present invention; and

FIG. 3 shows a flowchart for the method of data security in an electronic apparatus according to another embodiment of the present invention.

### DETAILED DESCRIPTION OF THE PREFERRED EMBODIMENTS

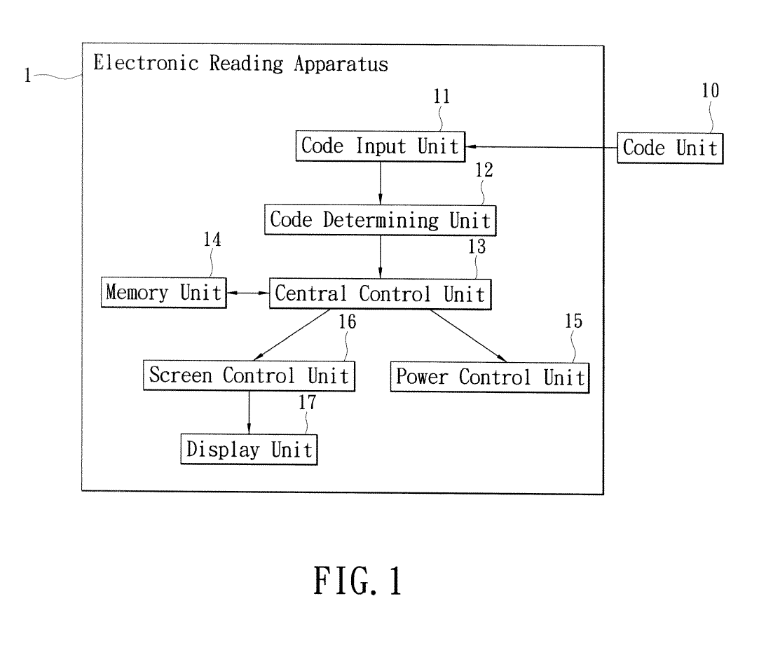

FIG. 1 shows an electronic apparatus with data security and anti-theft functions according to an embodiment of the present invention.

As shown in FIG. 1, an electronic reading apparatus 1 includes a code input unit 11, a code determining unit 12, a central control unit 13, a memory unit 14, a power control unit 15, a screen control unit 16 and a display unit 17.

The code input unit 11 allows a security code input or a biological characteristic of human operator through a code unit 10. The code determining unit 12 is connected to the code input unit 11, for comparing the received security code/biological characteristic with a predetermined code stored therein so as to generate an identification signal. The power control unit 15 provides the entire electronic reading apparatus 1 with the power supply required for operations according to a power drive signal. The display unit 17 is connected to the screen control unit 16 for displaying an image based on an image drive signal.

The central control unit 13 is connected to the code determining unit 12, the memory unit 14, the power control unit 15 and the screen control unit 16. The central control unit 13 may generate a power control signal based on the identification signal so as to control a power output of the power control unit 15. The central control unit 13 may also generate a screen control signal for controlling the screen control unit 16 before the generating of the image drive signal. The central control unit 13 may further access contents stored in the memory unit 14. Additionally, the memory unit 14 may store data to be protected, such as personal data of the human operator and business confidential data, so that the protected data may be accessed by the central control unit 13 before being shown on the display unit 17.

Furthermore, the central control unit 13 may also provide a timing function; for example, the central control unit 13 can determine whether the input of the security code is accomplished within a first predetermined period of time (in other words, whether the security code has been received within the first predetermined period of time), and also whether the electronic reading apparatus 1 receives any operational signal within a second predetermined period of time. It is worth noting that the first predetermined period and the second predetermined period may be pre-recorded in the memory unit 14. The code input unit 11 may be a card reader, a wireless signal receiver, a barcode scanner, a biosensor (e.g., brainwave detector, iris scanner, fingerprint identifier, voice identifier, face identifier etc.), but the present invention is by no means limited thereto, and the code input unit 11 may be implemented with any other suitable types of code input devices as well.

The code unit 10 may be an apparatus corresponding to any code input unit 11 employed by the user. For example, when the code input unit 11 is a contact card reader, the code unit 10 may be a magnetic card; when the code input unit 11 is a non-contact sensing card reader, the code unit 10 may be a chip card; further, suppose the code input unit 11 is a wireless signal receiver, the code unit 10 may be a wireless signal transmitter; and when the code input unit 11 is a barcode scanner, the code unit 10 may be a barcode card.

The non-contact sensing card reader described as above may utilize a wireless radio frequency identification technology enabling the non-contact sensing card reader to read the chip card actively and in a real-time fashion.

Besides, when the code input unit 11 is a biosensor, the code unit 10 may not be necessary as the biological characteristics of the human operators (e.g., brainwave, iris, fingerprint, voice profile, facial image and the like) may be received before the comparison with the pre-recorded information is performed.

Thus, it is appreciated that the code unit 10 could be in a form of a carrier loaded with the security code, like the magnetic card, the chip card, the wireless signal transmitter, the barcode card etc. When special information security measures are required, the biological characteristics of the human operators may be utilized so as to minimize the risk associated with the hacking and the lost/theft of the carrier with the security code.

The display unit 17 may be a display panel according to any display technology; in the present embodiment, the display panel utilizes the electronic paper display technology.

Since the electronic paper display technology featuring a bi-stable state characteristic, the display panel utilizing the electronic paper display technology requires no electrical power for continuous display of an image, increasing the likelihood that the personal data or other highly-sensitive data displayed on such display panel to be accessed without authorization.

Accordingly, the present invention proposes an electronic reading apparatus 1 with data security that is configured to display a prompt screen for code input and is suspended from additional operations when the electronic reading apparatus 1 has been turned on but receiving no operation signals for a while. The electronic reading apparatus 1 is also configured to clear the image displayed on the display unit 17 as no authentic security code or biological characteristic information has been received within a predetermined period of time.

When the human operator begins to use the electronic reading apparatus 1, it is required to first turn on the electronic reading apparatus 1 and then a prompt screen demanding the input of the security code or the biological characteristic of the human operator can be shown on the display unit 17. Meanwhile, the central control unit 13 starts counting. If the human operator enters the security code or the biological characteristic of the human operator has been received within a first predetermined period of time, the electronic reading apparatus 1 normally operates when the received security code or the biological characteristic of the human operator is authentic. Otherwise, the central control unit 13 generates a screen control signal to control the screen control unit 16 to clear the displayed image on the display unit 17, and generates a power control signal to the power control unit 15 to stop or reduce the power supply output, thereby shutting down or suspending the operation of the electronic reading apparatus 1. In doing so, the electronic reading apparatus 1 would be only accessed by the authorized person only.

According to the aforementioned discussions, the electronic reading apparatus 1 would not normally work with unauthorized code, if the electronic reading apparatus 1 is accidentally lost or stolen. Thus, the personal profile and confidential data stored in the apparatus would not be intruded for preventing the data leakage and data theft.

After turning on the electronic reading apparatus 1, the human operator may have to leave or need to work on other tasks without paying any attention on the electronic reading apparatus 1. At this moment, the operation of the electronic reading apparatus 1 has to be suspended to avoid the unauthorized access to the electronic reading apparatus 1. To achieve this purpose, the central control unit 13 may start counting while the electronic reading apparatus 1 has no operation signal received. When the counting time exceeds the second predetermined period of time, the central control unit 13 generates the screen control signal for controlling the screen control unit 16 to show a pop-up message on the display unit 17 for requesting an security code input or the biological characteristic and suspending the operation of the electronic reading apparatus 1; meanwhile, the central control unit 13 again determines whether any authentic security code/biological characteristic has been received within the first predetermined period of time.

At this point, if the human operator enters the authentic security code/biological characteristic within the first predetermined period the electronic reading apparatus 1 may resume its normal operations. On the contrary, the central control unit 13 may generate the screen control signal to control the screen control unit 16 so as to clear the contents shown on the display unit 17, and also generate the power control signal to control the power control unit 15 to stop or reduce the output of the power supply thereby turning off or suspending the operation of the electronic reading apparatus 1.

Consequently, the electronic reading apparatus 1 could be automatically shut down or suspended when the electronic reading apparatus 1 has not been in operation over the second predetermined period of time. And if no authentic security code/biological characteristic has been received within the first predetermined period of time after the electronic reading apparatus 1 has been suspended for failing to receive the operational signal within the second predetermined the central control unit may clear the displayed image.

The electronic reading apparatus 1 according to the present invention operates with the code unit 10 or the biological characteristic of the human operator, and the corresponding code input unit 11. In other words, the code unit 10 may serve as the source of the security code/biological characteristic of the human operator, which may be transmitted to and received by the code input unit 11. By comparing the received security code/biological characteristic of the human operator with the stored information, the electronic reading apparatus 1 may be turned off, normally operate, or clear the image displayed on the display unit 17.

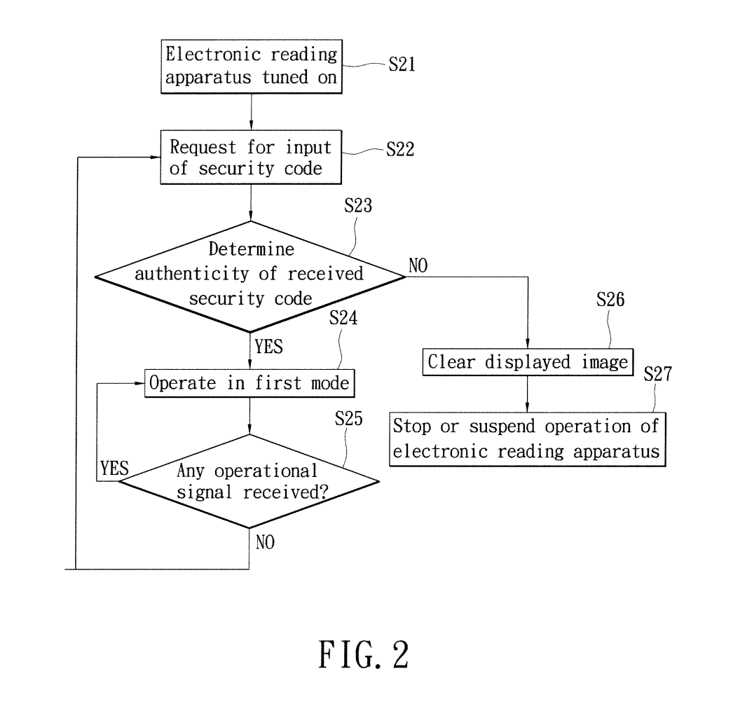

FIG. 2 shows a flowchart for the method of data security in an electronic apparatus according to an embodiment of the present invention.

When the human operator turns on the electronic reading apparatus 1, as shown in STEP S21, the electronic reading apparatus 1 presents a pop-up message requesting for the input of the security code/biological characteristic, as shown in STEP S22. Through the code determining unit 12, the electronic reading apparatus 1 may determine an authenticity of the received security code by comparing the received code with the pre-recorded code, as shown in STEP S23. If the received security code is authentic, the electronic reading apparatus 1 normally operates, as shown in STEP S24. Otherwise, the electronic reading apparatus 1 clears the contents on the display unit 17, as shown in STEP S26. It is worth noting that the electronic reading apparatus 1 may proceed to STEP S26, when no security code is received by the electronic reading apparatus 1 within the first predetermined period of time, or the received security code is determined unauthentic. And the electronic reading apparatus 1 may stop or suspend its operations, as shown in STEP S27.

When the electronic reading apparatus 1 operates in a first mode (for example, normally operate), as shown in STEP S24, the electronic reading apparatus 1 determines whether the electronic reading apparatus 1 receives any operation signal within the second predetermined period of time, as shown in STEP S25. If so, the electronic reading apparatus 1 may continuous normally operate (i.e., operate in the first mode), as illustrated in S25 to S24.

Otherwise, the electronic reading apparatus 1 may be configured to display a pop-up message for the input of the security while suspending the operation thereof, as illustrated in S25 and S22.

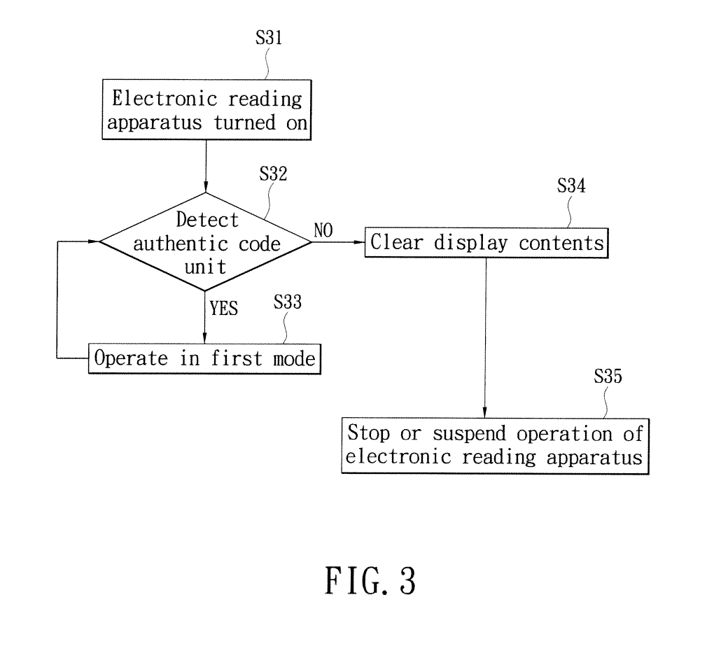

FIG. 3 shows a flowchart for the method of data security in an electronic apparatus according to another embodiment of the present invention.

After being turned on in STEP S31, the electronic reading apparatus 1 actively detects the presence of any authentic code unit 10 within its wireless reception range, as shown in STEP S32. In one implementation, the code input unit 11 in the electronic reading apparatus 1 may transmit the wireless signal in real-time or periodically to search for the presence of the code unit 10 with the wireless reception range, and determine the authenticity of the security code/biological characteristic in the code unit 10 by the code determining unit 12. Herein the transmissions between the code input unit 11 and the code determining unit 12 may be accomplished by using wireless radio frequency (RF) technology; for example, the code input unit 11 may be a non-contact sensing card reader and the code unit 10 may be a chip card.

When the determination in STEP S32 is affirmative, the electronic reading apparatus 1 is configured to normally operate (STEP S33). Otherwise, then the electronic reading apparatus 1 may clear the display image on the display unit 17, as shown in STEP S34, and stop or suspend the operation of the electronic reading apparatus 1, as shown in STEP S35.

Based on the approach illustrated in FIG. 3, the human operator may need to carry the code unit 10 having the security code (e.g., a chip card) within the wireless reception range of the electronic reading apparatus 1 without inputting the security code before accessing the electronic reading apparatus 1. On the other hand, the human operator is not in possession of the code unit 10 having the authentic security code or out of the wireless reception range of the electronic reading apparatus 1, the electronic reading apparatus 1 may automatically activate the data security mechanism such as clearing the displayed contents and suspending the operation of the electronic reading apparatus 1.

Consequently, when the electronic reading apparatus 1 is just shortly turned on, or has not been operating for a predetermined period of time, the operation of the electronic reading apparatus 1 may be temporarily suspended until after the receipt of the authentic security code.

Alternatively, suppose the electronic reading apparatus 1 has not been operating for a predetermined period of time or receiving no security code during another predetermined period of time, the electronic reading apparatus 1 may also clear the image shown on the display unit 17 and suspend the operation thereof. Therefore, the sensitive or confidential data shown on the display unit 17 of the electronic reading apparatus 1 may not be accessed without authorization.

However, the aforementioned illustrations merely set forth the detailed descriptions of the embodiments according to the present invention and the appended drawings thereof, rather than being applied to limit the present invention. The scope of the present invention should be based on the following claims. All changes, modifications or substitutions conveniently considered and made by those skilled ones in the art within the field of the present invention are deemed to be included in the scope of the present invention delineated by the subsequent claims.

What is claimed is:

1. An electronic reading apparatus, comprising:
a code input unit for receiving a code;
a code determining unit, connected to the code input unit, for generating an identification signal based on the code;
a power control unit, for outputting a power supply to the electronic reading apparatus;
a screen control unit, for outputting an image drive signal;
a display unit, connected to the screen control unit, for displaying an image based on the image drive signal; and
a central control unit, connected to the code determining unit, the power control unit and the screen control unit, for generating a screen control signal and a power control signal based on the identification signal in order to control the screen control unit to clear the image on the display unit and control the power control unit to stop outputting the power supply.

2. The electronic reading apparatus according to claim 1, wherein the code input unit is a card reader, a wireless signal receiver, a barcode scanner, one of biosensors, and the display unit is an electronic paper display panel.

3. The electronic reading apparatus according to claim 1, wherein the central control unit generates the screen control signal and the power control signal when the identification signal indicates the code is unauthentic.

4. A method of data security for an electronic reading apparatus, comprising:
(a) displaying a pop-up message for receiving a security code;
(b) determining an authenticity of the security code; and
(c) when the security code is determined unauthentic clearing an image shown on a display unit of the electronic reading apparatus and suspending or stopping an operation of the electronic reading apparatus.

5. The method of data security for an electronic reading apparatus according to claim 4, wherein the security code is recorded in one of a magnetic card, a wireless signal transmitter, a chip card and a barcode card, the security code is a biological characteristic of a human operator, and the display unit is an electronic paper display panel.

6. The method of data security for an electronic reading apparatus according to claim 4, wherein receiving the security code further comprising determining whether the security code is received within a first predetermined period of time.

7. The method of data security for an electronic reading apparatus according to claim 4, further comprising:
(d) when determining that the security code is authentic operating the electronic reading apparatus in a first mode, and when the electronic reading apparatus has been receiving no operational signals for more than a second predetermined period of time displaying the prompt screen for receiving the security code.

8. A method of data security for an electronic reading apparatus, comprising:
detecting whether an authentic security code is present in a wireless reception range of the electronic reading apparatus; and
when determining there is no authentic security code in the wireless reception range clearing an image shown on a display unit of the electronic reading apparatus and suspending or stopping an operation of the electronic reading apparatus.

9. The method of data security for an electronic reading apparatus according to claim 8, wherein the security code is stored within a chip card.

10. The method of data security for an electronic reading apparatus according to claim 8, further comprising:
When determining there is the authentic security code in the wireless reception range operating the electronic reading apparatus in a first mode.
